(19) United States
(12) Patent Application Publication
(10) Pub. No.: US 2019/0079876 A1
(43) Pub. Date: Mar. 14, 2019

(54) DIGITAL DEVICE AND METHOD FOR CONTROLLING THE SAME

(71) Applicant: LG ELECTRONICS INC., Seoul (KR)

(72) Inventors: Youngjin KIM, Seoul (KR); Gunho LEE, Seoul (KR)

(73) Assignee: LG ELECTRONICS INC., Seoul (KR)

(21) Appl. No.: 15/919,498

(22) Filed: Mar. 13, 2018

(30) Foreign Application Priority Data
Sep. 13, 2017 (KR) 10-2017-0116967

(51) Int. Cl. G06F 12/121; G06F 12/02; G06F 12/0864; H04N 21/443

(52) U.S. Cl. CPC G06F 12/121; H04N 21/4435; G06F 12/0864; G06F 12/0246

(57) ABSTRACT

Disclosed are a digital device and data processing method thereof. The present invention includes a first memory, a second memory used as a swap space of page data stored in the first memory, and a controller configured to control swap-in and swap-out operations for page data between the first memory and the second memory, wherein when page data in the first memory are swapped out to the second memory, the controller is further configured to swap out only one of a plurality of page data having the same substance among the page data to be swapped out to the second memory only.

Pursuant to 35 U.S.C. § 119(a), this application claims the benefit of earlier filing date and right of priority to Korean Application No. 10-2017-0116967, filed on Sep. 13, 2017, the contents of which are hereby incorporated by reference herein in their entirety.

### BACKGROUND OF THE INVENTION

### Field of the Invention

The present invention relates to a digital device, and more particularly, to a digital device and method for controlling the same. Although the present invention is suitable for a wide scope of applications, it is particularly suitable for providing a data swap function between two memories.

### Discussion of the Related Art

Mobile devices such as a smart phone, a tablet PC, a wearable device and the like are being developed fast as well as standing devices such as a personal computer (PC), a television (TV), a signage and the like. As the digital convergence booms up owing to the developments of mobile devices, a variety of mutual data communications are performed.

As described above, since various smart functions are mounted on a digital device, a volume of software increases so as to raise the use of high-end RAM (random access memory). Thus, the product manufacturing costs are raised.

In case of a computer, a swap function of backing up a portion of RAM used by an application in an operating system to a storage device such as a hard disk is used. Yet, in case of a flash memory embedded product such as a smartphone, a smart TV or the like, it is difficult to apply a swap technique of a PC due to a reduced life problem of the flash memory.

For example, in case of a flash memory of a general MCL (multi-level cell) type, the writing count (life) per cell is above 3,000. Hence, a current swap technique is popularly used for a PC storage device such as an HDD disk having no life problem.

### SUMMARY OF THE INVENTION

One technical task of the present invention is to provide a digital device and method for controlling the same, by which a flash memory can be used as a swap space of page data stored in RAM.

Another technical task of the present invention is to provide a digital device and method for controlling the same, by which a volume of RAM can be lowered using a flash memory as a swap space of RAM.

Further technical task of the present invention is to provide a digital device and method for controlling the same, by which the reduced life of a flash memory can be remarkably improved in case of using the flash memory as a swap space of RAM.

Technical tasks obtainable from the present invention are non-limited by the above-mentioned technical tasks. And, other unmentioned technical tasks can be clearly understood from the following description by those having ordinary skill in the technical field to which the present invention pertains.

To achieve these objects and other advantages and in accordance with the purpose of the invention, as embodied and broadly described herein, a digital device according to one embodiment of the present invention may include a first memory, a second memory used as a swap space of page data stored in the first memory, and a controller configured to control swap-in and swap-out operations for page data between the first memory and the second memory, wherein when page data in the first memory are swapped out to the second memory, the controller is further configured to swap out only one of a plurality of page data having the same substance among the page data to be swapped out to the second memory only.

Preferably, the first memory may include a random access memory (RAM) and the second memory may include a flash memory.

Preferably, the controller may calculate discrimination values for discriminating substances of the page data to be swapped out, respectively and determine that the substances of two or more page data having the same discrimination value among the calculated discrimination values are identical to each other.

More preferably, the discrimination value may include a hash value calculated by applying a preset hash function to the substances of the page data to be swapped out and the hash value may be calculated using all or some of the substances of the page data to be swapped out.

The controller may store swap information on at least one page data failing to be swapped out to the second memory among the page data having the same substances to the first memory. When swapping in the page data swapped out to the second memory to the first memory, the controller may reconstruct the at least one page data failing to be swapped out based on the swap information stored to the first memory. And, the controller may swap in the page data swapped out to the second memory and the reconstructed at least one page data to the first memory.

The first memory may include a mapping table. The controller may perform an operation of recording the mapping table in a manner of mapping a discrimination value of each of the page data to be swapped out and each storage location to be swapped out to the flash memory to a swap offset of each of the page data to be swapped out. While the operation is performed, when the discrimination value of a first page data is equal to that of the second page data already recorded in the mapping table, the controller may connect the swap offset of the first page data to the storage location of the second page data in the mapping table.

The swap information may include the storage location of the second page data connected to the swap offset value of the first page data. When swapping in the first page data, which is not swapped out to the second memory, to the first memory, the controller may search for the storage location of the second page data connected to the swap offset of the first page data in the mapping table, change the second page data stored in the searched storage location into the first page data, and swap in the changed data to the first memory.

The controller may sequentially perform compression on a plurality of page data, which fail to have the same substances among the page data to be swapped out, by a preset compression scheme, assign a storage space amounting to a compressed size of each of the page data failing to have the same substances in the second memory by referring to the mapping table, and connect a location of each of the assigned storage spaces to a swap offset value and a discrimination value of each of the page data failing to have the same substances.

And, the controller may perform buffering until a total size of the sequentially compressed page data becomes equal to or greater than a minimum size inputtable/outputtable to/from the second memory. When the total size of the sequentially compressed page data becomes equal to or greater than the minimum size inputtable/outputtable to/from the second memory, the controller may swap out the buffered page data to the second memory.

In another aspect of the present invention, a method of controlling a digital device having a first memory and a second memory used as a swap space of page data stored in the first memory according to one embodiment of the present invention may include receiving a swap-out request for storing page data in the first memory to the second memory, obtaining a plurality of page data having the same substances among the page data to be swapped out, and swapping out only one of the obtained page data to the second memory in swapping out the page data to the second memory.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1 is a schematic diagram illustrating a service system according to one embodiment of the present invention;

FIG. 2 is a block diagram showing the configuration of a digital TV according to one embodiment of the present invention;

FIG. 3 is a block diagram showing the configuration of a digital TV according to another embodiment of the present invention;

FIG. 4 is a diagram showing the configuration of a mobile terminal according to one embodiment of the present invention;

FIG. 5 is a diagram showing a control means for controlling a digital device according to one embodiment of the present invention;

FIG. 6 is a diagram to describe a hard disk based swap technique of the related art and a flash memory based swap technique according to the present invention;

FIG. 7 is a diagram to describe a swap-out process between a RAM and a flash memory according to the present invention;

FIG. 8 is a flowchart for an operating process of a deduplication module according to the present invention;

FIG. 9 is a diagram of a mapping table used in determining a presence or non-presence of duplication of page data according to the present invention;

FIG. 10 is a diagram to describe a process for deduplicating page data to be swapped out according to the present invention;

FIG. 11 is a flowchart for an operating process of a compression module according to the present invention;

FIG. 12 is a diagram to describe a process for compressing deduplicated page data according to the present invention;

FIG. 13 is a flowchart for an operating process of a mapping module according to the present invention;

FIG. 14 is a flowchart for an operating process of a write buffering module according to the present invention;

FIG. 15 is a diagram to describe a process for swapping out compressed page data to a flash memory by merging the compressed page data according to the present invention;

FIG. 16 is a diagram to describe a swap-in process between a RAM and a flash memory according to the present invention;

FIG. 17 is a flowchart of a process for turning off a swap function using a mapping table according to the present invention; and

FIG. 18 is a flowchart of a process for turning on a swap function using a mapping table according to the present invention.

### DETAILED DESCRIPTION OF THE INVENTION

Description will now be given in detail according to various embodiment(s) for a digital device and data processing method therein disclosed herein, with reference to the accompanying drawings.

Suffixes such as “module”, “unit” and the like in this disclosure may be used to refer to elements or components. Use of such a suffix herein is merely intended to facilitate description of the specification, and both suffixes may be interchangeably usable. The description with ordinal numbers such as ‘first˜’, ‘second˜’ and the like is provided to facilitate the description of the corresponding terminologies only, which is non-limited by such terminologies or ordinal numbers. Although terminologies used in the present specification are selected from general terminologies used currently and widely in consideration of functions in the present invention, they may be changed in accordance with intentions of technicians engaged in the corresponding fields, customs, advents of new technologies and the like. Occasionally, some terminologies may be arbitrarily selected by the applicant(s). In this case, the meanings of the arbitrarily selected terminologies shall be described in the corresponding part of the detailed description of the invention. Therefore, terminologies used in the present specification need to be construed based on the substantial meanings of the corresponding terminologies and the overall matters disclosed in the present specification rather than construed as simple names of the terminologies. Meanwhile, the descriptions disclosed in the present specification and/or drawings correspond to one preferred embodiment of the present invention and are non-limited by the preferred embodiment. And, the scope/extent of the right should be determined through the appended claims.

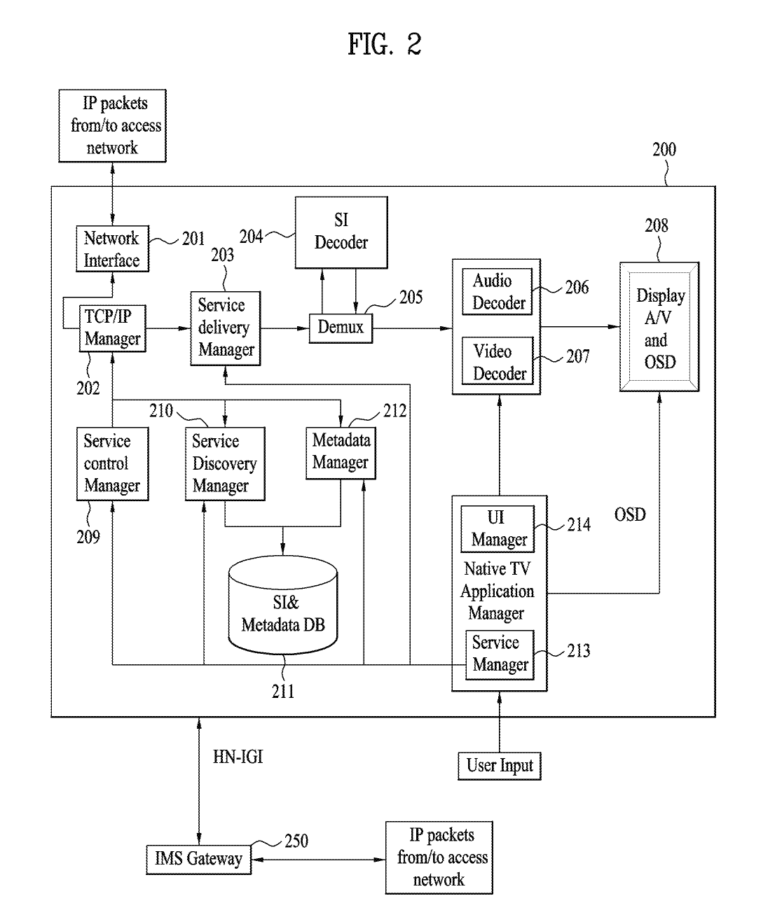

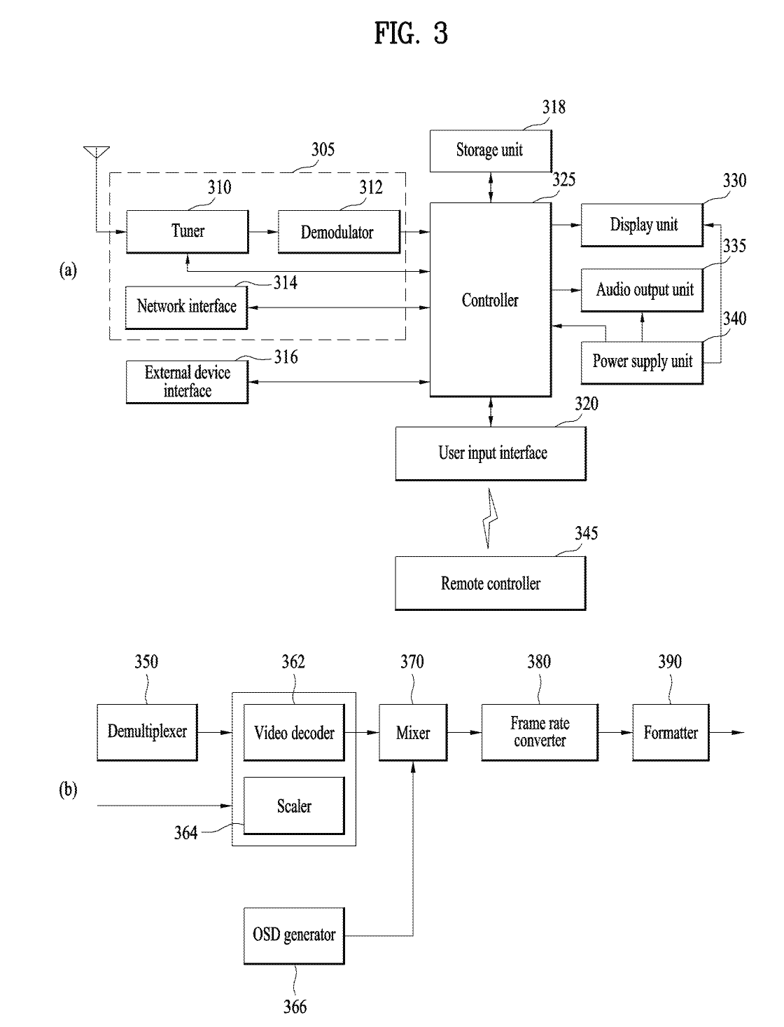

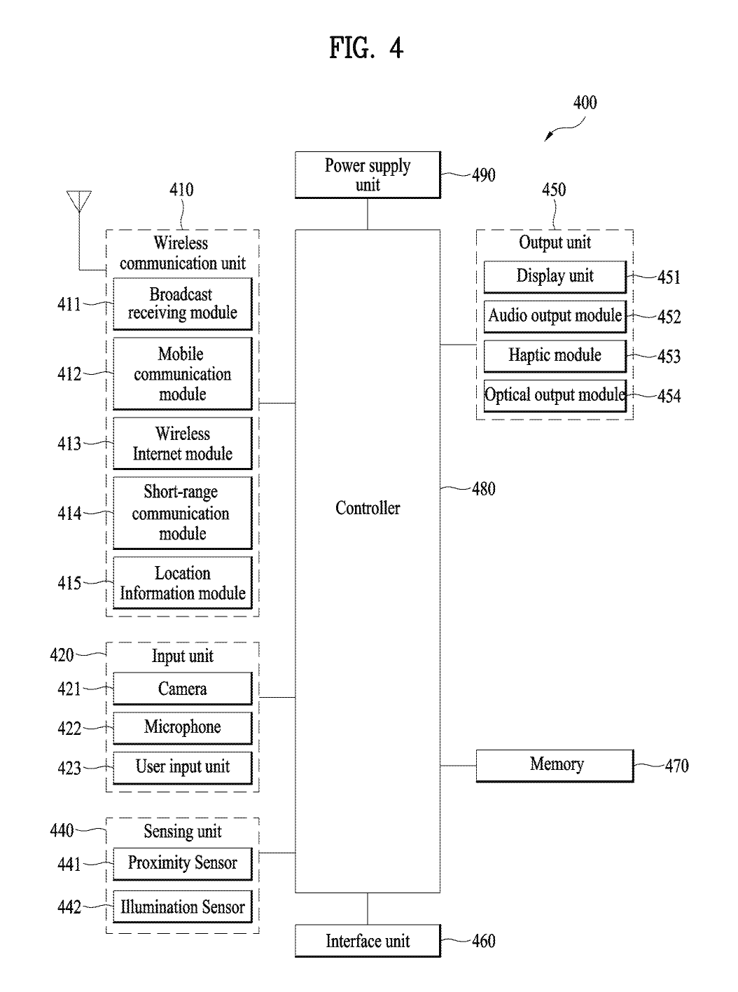

‘Digital device’ described in the present specification includes any device capable of performing at least one of transmission, reception, processing and output of contents for example. The digital device can receive the content or information on the content by streaming or download through a server (e.g., a broadcasting station), an external input or the like. The digital device may transmit/receive data including the content to/from the server or the like through a wire/wireless network. The digital device may include one of a fixed (or standing) device and a mobile device. The standing devices may include Network TV, HBBTV (Hybrid Broadcast Broadband TV), Smart TV, IPTV (Internet Protocol TV), PC (Personal Computer), etc. And, the mobile devices may include PDA (Personal Digital Assistant), Smart Phone, Tablet PC, Notebook, Digital Broadcast Terminal, PMP (portable multimedia player), Navigation, Slate PC, Ultrabook, Wearable Device (e.g., watch type terminal, glass type terminal, HMD (head mounted display), etc. For example of digital devices, FIG. 2 and FIG. 3 show a digital TV as one of the standing devices and FIG. 4 shows a mobile terminal (including a wearable device such as a smart watch) as one of the mobile devices. And, such digital devices shall be described in detail for the corresponding parts. If the digital device is the standing device, it may have include a signage having a display panel only or a SET type with another configuration such as a set-top box (STB) and the like.

Meanwhile, the wire/wireless network described in the present specification includes all hardware and/or software for a connection, pairing, data communication and the like between a server and a digital device, and also includes all networks supported currently or all networks that will be supported in the future, by Standards. The wire/wireless network is capable of supporting one or more communication protocols for data communications. Such wire/wireless networks can be established by a network for a wire connection and a communication specification or protocol for the same (e.g., USB (Universal Serial Bus), CVBS (Composite Video Banking Sync), Component, S-video (analog), DVI (Digital Visual Interface), HDMI (High Definition Multimedia Interface), RGB, D-SUB, etc.) and a network for a wireless connection and a communication specification or protocol (e.g., Bluetooth, RFID (Radio Frequency Identification), IrDA (infrared Data Association), UWB (Ultra Wideband), ZigBee, DLNA (Digital Living Network Alliance), WLAN (Wireless LAN)(Wi-Fi), Wibro (Wireless broadband), Wimax (World Interoperability for Microwave Access), HSDPA (High Speed Downlink Packet Access), LTE/LTE-A (Long Term Evolution/LTE-Advanced), Wi-Fi direct).

Besides, a digital device may use a universal OS (operating system), a Web OS and the like. Hence, the digital device can process adding, deleting, amending, updating and the like of various services or applications on Universal OS kernel or Linux kernel, through which a further user-friendly environment can be configured and provided.

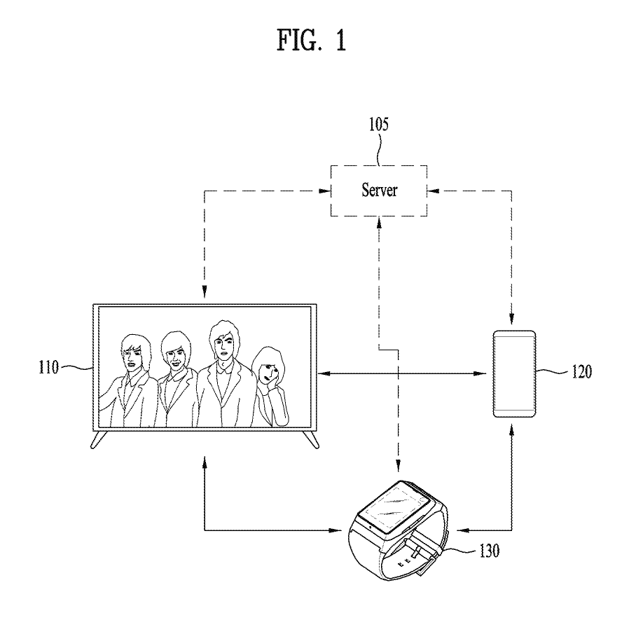

FIG. 1 is a schematic diagram illustrating a service system according to one embodiment of the present invention.

Referring to FIG. 1, a service system may be implemented by including a sever 105 and a digital TV 110. Herein, the digital TV 110 may be substituted with a mobile terminal such as a smartphone 120 or a wearable device 130. Alternatively, the service system may be implemented by including the server 105, the digital TV 110 and the mobile terminals 120 and 130.

FIG. 2 is a block diagram showing the configuration of a digital TV according to one embodiment of the present invention.

The digital TV 200 may include a network interface 201, a TCP/IP manager 202, a service delivery manager 203, an SI decoder 204, a demux or demultiplexer 205, an audio decoder 206, a video decoder 207, a display A/V and OSD (On Screen Display) module 208, a service control manager 209, a service discovery manager 210, a SI & metadata database (DB) 211, a metadata manager 212, a service manager 213, a UI manager 214, etc.

The network interface 201 may transmit/receive IP (internet protocol) packet(s) or IP datagram(s) (hereinafter named IP pack(s)) to/from the server 105 through a network. For instance, the network interface 201 may receive services, applications, contents and the like from the service provider through a network.

The TCP/IP manager 202 may involve delivery of IP packets transmitted to the digital TV 200 and IP packets transmitted from the digital TV 200, that is, packet delivery between a source and a destination. The TCP/IP manager 202 may classify received packet(s) according to an appropriate protocol and output the classified packet(s) to the service delivery manager 205, the service discovery manager 210, the service control manager 209, the metadata manager 212, and the like.

The service delivery manager 203 may be in charge of controlling the received service data. The service delivery manager 203 may control real-time streaming data, for example, using RTP/RTCP. In case of transmitting the real-time streaming data using RTP, the service delivery manager 203 may parse the received data packet according to the RTP and then transmits the parsed data packet to the demultiplexer 205 or save the parsed data packet to the SI & metadata DB 211 under the control of the service manager 213. The service delivery manager 203 may feed back the network reception information to the service providing server side using RTCP.

The demultiplexer 205 may demultiplex a received packet into audio data, video data, SI (System Information/Service Information/Signaling Information) data and the like and then transmit the demultiplexed data to the audio/video decoder 206/207 and the SI decoder 204, respectively.

The SI decoder 204 may decode the demultiplexed SI data, i.e., service informations of PSI (Program Specific Information), PSIP (Program and System Information Protocol), DVB-SI (Digital Video Broadcasting-Service Information), DTMB/CMMB (Digital Television Terrestrial Multimedia Broadcasting/Coding Mobile Multimedia Broadcasting), etc. And, the SI decoder 204 may save the decoded service informations to the SI & metadata DB 211. The saved service information can be used by being read by a corresponding component in response to a user's request for example.

The audio decoder 206 and the video decoder 207 may decode the demultiplexed audio data and the demultiplexed video data, respectively. The decoded audio and video data may be provided to the user through the display unit 208.

The application manager includes a service manager 213 and a user interface (UI) manager 214 and is able to perform a function of a controller of the digital TV 200. So to speak, the application manager can administrate the overall states of the digital TV 200, provide a user interface (UI), and manage other mangers.

The UI manager 214 provides a graphical user interface/user interface (GUI/UI) using OSD (on screen display) and the like. The UI manager 214 receives a key input from a user and then performs a device operation according to the input. For instance, if receiving a key input about a channel selection from a user, the UI manager 214 transmits the key input signal to the service manager 213.

The service manager 213 may control and manage service-related managers such as the service delivery manager 203, the service discovery manager 210, the service control manager 209, and the metadata manager 212. The service manager 213 creates a channel map and controls a selection of a channel and the like using the created channel map in response to a key input received from the UI manager 214. The service manager 213 may receive service information from the SI decoder 204 and then sets an audio/video PID of a selected channel for the demultiplexer 205. Such a PID can be used for the demultiplexing procedure. Therefore, the demultiplexer 205 performs filtering (PID or section filtering) on audio data, video data and SI data using the PID.

The service discovery manager 210 may provide information required to select a service provider that provides a service. Upon receipt of a signal for selecting a channel from the service manager 213, the service discovery manager 210 searches for a service using the information.

The service control manager 209 may select and control a service. For example, the service control manager 209 may perform service selection and control using IGMP (Internet Group Management Protocol) or real time streaming protocol (RTSP) when the user selects a live broadcast service and using RTSP when the user selects a video on demand (VOD) service. The RTSP protocol can provide a trick mode for real-time streaming. And, the service control manager 209 may initialize and manage a session through the IMS gateway 250 using IMS (IP multimedia subsystem) and SIP (session initiation protocol). The protocols are exemplary, and other protocols are usable according to implementations.

The metadata manager 212 may manage metadata associated with services and save the metadata to the SI & metadata DB 211.

The SI & metadata DB 211 may store service information decoded by the SI decoder 204, metadata managed by the metadata manager 212, and information required to select a service provider, which is provided by the service discovery manager 210. In addition, the SI & metadata DB 211 can store system set-up data and the like for the system. The SI & metadata database 211 may be implemented with non-volatile RAM (NVRAM), flash memory and the like.

Meanwhile, an IMS gateway 250 is a gateway in which functions required for an access to an IMS based IPTV service are collected.

FIG. 3 is a block diagram showing a digital TV according to another embodiment of the present invention.

Another example of a digital TV may include a broadcast receiving unit 305, an external device interface 316, a storage unit 318, a user input interface 320, a controller 325, a display unit 330, an audio output unit 335, a power supply unit 340, and a photographing unit (not shown). Herein, the broadcast receiving unit 305 may include at least one of one tuner 310, a demodulator 312, and a network interface 314. Yet, in some cases, the broadcast receiving unit 305 may include the tuner 310 and the demodulator 312 without the network interface 314, or may include the network interface 314 without the tuner 310 and the demodulator 312. The broadcast receiving unit 305 may include a multiplexer (not shown) to multiplex a signal, which is subjected to the tuner 310 and demodulated by the demodulator 312, and a signal received through the network interface 314. In addition, the broadcast receiving unit 305 can include a demultiplexer (not shown) and demultiplex the multiplexed signal, the demodulated signal, or a signal received through the network interface 314.

The tuner 310 may receive a radio frequency (RF) broadcast signal by tuning in to a channel selected by the user or all previously stored channels among RF broadcast signals received through an antenna. And, the tuner 310 converts the received RF broadcast signal into an IF (intermediate frequency) signal or a baseband signal. For instance, if a received RF broadcast signal is a digital broadcast signal, it is converted into a digital IF (DIF) signal. If a received RF broadcast signal is an analog signal, it is converted into an analog baseband video/audio signal (CVBS/SIF). Namely, the tuner 310 is able to process both of the digital broadcast signal and the analog signal. The analog baseband video/audio signal (CVBS/SIF) outputted from the tuner 310 may be directly inputted to the controller 325. The tuner 310 may receive an RF broadcast signal of a single carrier or multiple carriers. The tuner 310 sequentially tunes in to and receives RF broadcast signals of all broadcast channels stored through the channel memory function among RF broadcast signals received through the antenna and is then able to convert it into an intermedia frequency signal or a baseband signal (DIF: digital intermediate frequency or baseband signal).

The demodulator 312 receives and demodulates the digital IF signal (DIF) converted by the tuner 310 and is then able to channel decoding and the like. To this end, the demodulator 312 may include a Trellis decoder, a de-interleaver, a Reed-Solomon decoder and the like, or may include a convolution decoder, a de-interleaver, a Reed-Solomon decoder and the like. The demodulator 312 performs demodulation and channel decoding and is then able to output a stream signal TS (transport stream). In this case, the stream signal may include a signal of multiplexing a video signal, an audio signal and/or a data signal. For instance, the stream signal may include MPEG-2 TS (transport stream) in which a video signal of PMEG-2 and an audio signal of Dolby AC-3 are multiplexed. The stream signal outputted from the demodulator 312 may be inputted to the controller 325. The controller 325 can control demultiplexing, audio/video signal processing, etc. Furthermore, the controller 325 can control outputs of video and audio through the display 330 and the audio output unit 335, respectively.

The external device interface 316 may provide an interfacing environment between the digital device 300 and various external devices. To this end, the external device interface 316 may include an A/V input/output unit (not shown) or a wireless communication unit (not shown). The external device interface 316 can be connected with external devices such as a digital versatile disk (DVD), a Blu-ray player, a game device, a camera, a camcorder, a computer (notebook computer), a tablet PC, a smartphone, a cloud and the like by wire/wireless. The external device interface 316 delivers a signal containing data such as an image, a video, an audio and the like, which is inputted through the connected external device, to the controller 325 of the digital TV. The controller 325 may control a data signal of the processed image, video and audio and the like to be outputted to the connected external device. To this end, the external device interface 316 may further include an A/V input/output unit (not shown) or a wireless communication unit (not shown).

In order to input video and audio signals of an external device to the digital TV, the A/V input/output unit may include a USB (Universal Serial Bus) terminal, a composite video banking sync (CVBS) terminal, a component terminal, an S-video terminal (analog), a digital visual interface (DVI) terminal, a high definition multimedia interface (HDMI) terminal, an RGB terminal, a D-SUB terminal, etc.

The wireless communication unit can perform short-range wireless communication with another digital device. The digital TV may be networked with other digital devices by communication protocols such as Bluetooth, radio frequency identification (RFID), infrared data association (IrDA), ultra wideband (UWB), ZigBee, and digital living network alliance (DLNA), etc. for example.

The external device interface 316 may perform input/output operations with a set-top box (STB) by being connected thereto through at least one of the aforementioned terminals Meanwhile, the external device interface 316 may receive an application or an application list within an adjacent external device and then forward it to the controller 325 or the storage unit 318.

The network interface 314 may provide an interface for connecting the digital TV to wired/wireless networks including Internet network. The network interface 314 may have Ethernet terminal and the like for an access to a wired network for example. For the access to the wireless network, the network interface 314 may use communication specifications such as WLAN (Wireless LAN) (Wi-Fi), Wibro (Wireless broadband), Wimax (World Interoperability for Microwave Access), HSDPA (High Speed Downlink Packet Access), etc. The network interface 314 may transceive data with another user or another digital device through the accessed network or another network linked to the accessed network. Particularly, the network interface 314 may send a portion of the content data stored in the digital TV to a user/digital device selected from other users/digital devices previously registered at the digital TV. Meanwhile, the network interface 314 may access a prescribed webpage through the accessed network or another network linked to the accessed network. Namely, the network interface 314 accesses a prescribed webpage through a network and is then able to transceive data with a corresponding server. Besides, the network interface 314 can receive contents or data provided by a content provider or a network operator. Namely, the network interface 314 may receive contents (e.g., movie, advertisement, game, VOD, broadcast signal, etc.) provided by the content provider or a network provider and information associated with the contents through the network. The network interface 314 may receive update information and file of firmware provided by the network operator. And, the network interface 314 may send data to the internet or content provider or the network operator. Moreover, the network interface 314 may select a desired application from open applications and receive it through a network.

The storage unit 318 may store programs for various signal processing and controls within the controller 325, and may also store a processed video, audio or data signal. In addition, the storage unit 318 may execute a function of temporarily storing a video, audio or data signal inputted from the external device interface 316 or the network interface 314. The storage unit 318 may store information on a prescribed broadcast channel through a channel memory function. The storage unit 318 may store an application or an application list inputted from the external device interface 316 or the network interface 314. And, the storage unit 318 may store various platforms which will be described later. The storage unit 318 may include storage media of one or more types, such as a flash memory type, a hard disk type, a multimedia card micro type, a card type memory (e.g. SD or XD memory), RAM, EEPROM, etc. The digital TV may play content files (a video file, a still image file, a music file, a text file, an application file, etc.) stored in the storage unit 318 and provide them to the user. FIG. 3 (a) illustrates an embodiment in which the storage unit 318 is separated from the controller 325, by which the present invention is non-limited. In other words, the storage unit 318 may be included in the controller 325.

The user input interface 320 may forward a signal inputted by a user to the controller 325 or forward a signal outputted from the controller 325 to the user. For example, the user input interface 320 may receive control signals for power on/off, channel selection, screen settings and the like from a remote controller 345, or transmit control signals of the controller 325 to the remote controller 345, according to various communication schemes such as RF communication, IR communication, and the like. The user input interface 320 can forward control signals inputted through a power key, a channel key, a volume key, and a local key (not shown) for a setup value or the like to the controller 325. The user input interface 320 may forward a control signal inputted from a sensing unit (not shown) sensing a gesture of a user to the controller 325 or transmit a signal of the controller 325 to the sensing unit (not shown). Here, the sensing unit (not shown) may include a touch sensor, a voice sensor, a location sensor, an action sensor, etc.

The controller 325 may generate and output a signal for a video or audio output by demultiplexing a stream inputted through the tuner 310, the demodulator 312 or the external device interface 316 or processing demultiplexed signals. A video signal processed by the controller 325 can be inputted to the display unit 380 and displayed as an image corresponding to the video signal. In addition, the video signal video-processed by the controller 325 can be inputted to an external output device through the external device interface 316. An audio signal processed by the controller 325 can be audio-outputted to the audio output unit 335. Moreover, the audio signal processed by the controller 325 can be inputted to the external output device through the external device interface 316. The controller 325 may include a demultiplexer, an image processor, and the like, which are not shown in FIG. 3 (a). The controller 325 can control the overall operations of the digital TV. For example, the controller 325 can control the tuner 310 to tune in to an RF broadcast corresponding to a channel selected by a user or a previously stored channel. The controller 325 can control the digital TV according to a user command input through the user input interface 320 or an internal program. Particularly, the controller 325 can control the digital TV to access a network to download an application or an application list desired by a user to the digital TV. For example, the controller 325 may control the tuner 310 to receive a signal of a channel selected in response to a prescribed channel selection command received through the user input interface 320. And, the controller 325 may process a video, audio or data signal of the selected channel. The controller 325 may control information on a channel selected by the user to be outputted together with a processed video or audio signal through the display unit 330 or the audio output unit 335. For another example, the controller 325 may control a video signal or an audio signal, which is inputted through the external device interface unit 316 from an external device (e.g., a camera or a camcorder), to be outputted through the display unit 330 or the audio output unit 335 in response to an external device image play command received through the user input interface 320. Meanwhile, the controller 325 can control the display unit 330 to display a video. For example, the controller 325 can control a broadcast video inputted through the tuner 310, an external input video inputted through the external device interface 316, a video inputted through the network interface 430, or a video stored in the storage unit 440 to be displayed on the display unit 330. Here, the video displayed on the display unit 330 may include a still image or moving images or may include a 2D or 3D video. The controller 325 may control a content to be played. Here, the content may include a content stored in the digital TV, a received broadcast content, or a content inputted externally. The content may include at least one of a broadcast video, an external input video, an audio file, a still image, an accessed web screen, and a document file. The controller 325 may control an application or an application list, which is located in the digital device 300 or downloadable from an external network, to be displayed when an application view menu is entered. The controller 325 may control installation and execution of applications downloaded from an external network together with various user interfaces. Moreover, the controller 325 can control a video related to a launched application to be displayed on the display unit 330 by a user's selection.

Meanwhile, a channel browsing processor (not shown) configured to generate a thumbnail image corresponding to a channel signal or an external input signal may be further included. The channel browsing processor may receive an input of a stream signal (TS) outputted from the demodulator 312 or an input of a stream signal outputted from the external device interface 316, extract a video from the inputted stream signal, and then generate a thumbnail image. The generated thumbnail image can be directly inputted to the controller 325 or may be inputted to the controller 325 by being encoded. Moreover, the generated thumbnail image may be encoded into a stream and then inputted to the controller 325. The controller 325 may display a thumbnail list including a plurality of thumbnail images on the display unit 330 using the inputted thumbnail images. The thumbnail images included in the thumbnail list can be updated sequentially or simultaneously. Accordingly, the user can conveniently check content of a plurality of broadcast channels.

The display unit 330 may convert each of a video signal, a data signal, and an OSD signal processed by the controller 325 or each of a video signal and a data signal received from the external device interface 316 into R, G and B signals to generate a drive signals. The display unit 330 may include PDP (Plasma Display Panel), LCD (Liquid Crystal Display), OLED (Organic Light Emitting Diode), a flexible display, a 3D display, or the like. The display unit 330 may be configured as a touchscreen and used as an input device as well as an output device. The audio output unit 335 receives a signal audio-processed by the controller 325, for example, a stereo signal, a 3.1 channel signal or a 5.1 channel signal, and then outputs the received signal as audio. The audio output unit 335 may be configured as one of speakers of various types.

Meanwhile, the digital TV may further include the sensing unit (not shown) for sensing a gesture of the user, which includes at least one of a touch sensor, a voice sensor, a location sensor, and an action sensor, as described above. A signal sensed by the sensing unit (not shown) can be delivered to the controller 325 through the user input interface 320. The digital TV may further include a photographing unit (not shown) for photographing a user. Image information acquired by the photographing unit (not shown) can be inputted to the controller 325. The controller 325 may sense a gesture of a user from an image captured by the photographing unit (not shown) or a signal sensed by the sensing unit (not shown), or by combining the image and the signal.

The power supply unit 340 may supply a corresponding power to the digital TV overall. Particularly, the power supply unit 340 can supply the power to the controller 325 configurable as a system-on-chip (SoC), the display unit 330 for a video display, and the audio output unit 335 for an audio output. To this end, the power supply unit 340 may include a converter (not shown) configured to convert an AC power to a DC power. Meanwhile, for example, if the display unit 330 is configured as an LCD panel having a multitude of backlight lamps, the power supply unit 340 may further include an inverter (not shown) capable of PWM (pulse width modulation) operation for luminance variation or dimming drive.

The remote controller 345 sends a user input to the user input interface 320. To this end, the remote controller 345 can use Bluetooth, RF communication, IR communication, UWB, ZigBee, etc. In addition, the remote controller 345 can receive audio, video or data signal outputted from the user input interface 320 and then display the received signal or output the same as audio or vibration.

Regarding the digital device according to the present invention, some of the illustrated components may be omitted or new components (not shown) may be further added as required. On the other hand, the digital device may not include the tuner and the demodulator, differently from the aforementioned digital device, and may play a content by receiving the content through the network interface or the external device interface.

Referring to FIG. 3(b), one example of the controller may include a demultiplexer 350, a video processor, an OSD generator 366, a mixer 370, a frame rate converter (FRC) 380, and a formatter 390. Besides, the controller may further include an audio processor and a data processor (not shown).

The demultiplexer 350 demultiplexes an inputted stream. For instance, the demultiplexer 350 can demultiplex an inputted stream signal into an MPEG-2 TS video, audio and data signals. Herein, the stream signal inputted to the demultiplexer may include a stream signal outputted from the tuner, demodulator or external device interface.

The video processor performs a video processing of the demultiplexed video signal. To this end, the video processor may include a video decoder 362 and a scaler 364. The video decoder 362 can decode the demultiplexed video signal, and the scaler 364 can scale the resolution of the decoded video signal to be outputtable from the display. The video decoder 362 can support various specifications. For instance, the video decoder 362 performs a function of MPEG-2 decoder if a video signal is encoded by MPEG-2. And, the video decoder 364 performs a function of H.264 decoder if a video signal is encoded by DMB (digital multimedia broadcasting) or H.264. Meanwhile, the video signal decoded by the image processor is inputted to the mixer 370.

The OSD generator 366 may generate OSD data according to a user input or by itself. For example, the OSD generator 366 may generate data to be displayed on the screen of the display 380 in the graphic or text form on the basis of a control signal of a user input interface. The generated OSD data may include various data such as a user interface screen of the digital device, various menu screens, widgets, icons, viewing rate information and the like. The OSD generator 366 can generate data to display a caption of a broadcast video or EPG based broadcast information.

The mixer 370 mixes the OSD data generated by the OSD generator 366 and the video signal processed by the video processor. The mixer 370 then provides the mixed signal to the formatter 390. By mixing the decoded video signal and the OSD data, OSD is displayed in a manner of overlaying a broadcast video or an external input video.

The frame rate converter (FRC) 380 may convert a frame rate of an inputted video. For example, the frame rate converter 380 can convert the frame rate of an inputted 60 Hz video into a frame rate of 120 Hz or 240 Hz according to an output frequency of the display unit. As described above, there may exist various methods of converting a frame rate. For instance, in case of converting a frame rate into 120 HZ from 60 Hz, the frame rate converter 380 can perform the conversion by inserting a first frame between the first frame and a second frame or inserting a third frame predicted from the first and second frames. For another instance, in case of converting a frame rate into 240 Hz from 60 Hz, the frame rate converter 380 can perform the conversion by further inserting three same or predicted frames between the existing frames. Meanwhile, in case of not performing a separate frame conversion, the frame rate converter 380 may be bypassed.

The formatter 390 may change the output of the frame rate converter 380, which is inputted thereto, to fit an output format of the display unit. For example, the formatter 390 can output an RGB data signal. In this case, this RGB data signal can be outputted as low voltage differential signal (LVDS) or mini-LVDS. If an inputted output of the frame rate converter 380 is a 3D video signal, the formatter 390 outputs the signal by configuring a 3D format to fit the output format of the display unit, whereby a 3D service can be supported through the display unit.

Meanwhile, an audio processor (not shown) in the controller can perform audio processing of a demultiplexed audio signal. Such an audio processor (not shown) can provide supports to process various audio formats. For instance, if an audio signal is encoded in format of MPEG-2, MPEG-4, AAC, HE-AAC, AC-3, BSAC, or the like, a corresponding decoder is further included to process the audio signal. And, the audio processor (not shown) in the controller can process base, treble, volume adjustment and the like. A data processor (not shown) in the controller can process a demultiplexed data signal. For example, when a demultiplexed data signal is encoded, the data processor can decode the encoded demultiplexed data signal. Here, the encoded data signal may be EPG information including broadcast information such as start and end times of a broadcast program broadcasted on each channel, and the like.

Meanwhile, the above-described digital TV is one example according to the present invention. And, at least one of the components may be integrated, added or omitted depending on options of an actually embodied digital TV. In particular, if necessary, at least two or more components can be integrated into a single component or a prescribed component can be divided into at least two or more components. Moreover, a function performed by each block is provided to describe one embodiment of the present invention. A detailed operation or device for the function may non-limit the scope of the appended claims and their equivalents of the present invention. Meanwhile, a digital TV may include an image signal processing device configured to process a signal of an image saved in the corresponding device or a signal of an inputted image. Examples of the image signal processing device may include a settop box (STB) failing to include the display unit 330 and the audio output unit 335 shown in FIG. 3 (a), the aforementioned DVD player, a Blu-ray player, a game device, a computer and the like.

FIG. 4 is a block diagram showing the configuration of a mobile terminal according to one embodiment of the present invention.

Referring to FIG. 4, the mobile terminal 400 includes a wireless communication unit 410, an AN (audio/video) input unit 420, a user input unit 430, a sensing unit 440, an output unit 450, a memory 460, an interface unit 470, a controller 480, a power supply unit 490, etc.

The wireless communication unit 410 typically includes one or more modules which permit wireless communication between the mobile terminal 400 and a wireless communication system or network within which the mobile terminal 400 is located. For instance, the wireless communication unit 410 can include a broadcast receiving module 411, a mobile communication module 412, a wireless Internet module 413, a short-range communication module 414, a location information module 415, etc.

The broadcast receiving module 411 receives a broadcast signal and/or broadcast associated information from an external broadcast managing server via a broadcast channel The broadcast channel may include a satellite channel and a terrestrial channel. The broadcast managing server may mean a server generating to send a broadcast signal and/or broadcast associated information or a server receiving to send a pre-generated broadcast signal and/or broadcast associated information to a terminal. The broadcast signal may be implemented as a TV broadcast signal, a radio broadcast signal, and/or a data broadcast signal, among other signals. If desired, the broadcast signal may further include a broadcast signal combined with a TV or radio broadcast signal. The broadcast associated information may include information associated with a broadcast channel, a broadcast program, or a broadcast service provider. Furthermore, the broadcast associated information can be provided via a mobile communication network. In this case, the broadcast associated information can be received by the mobile communication module 412. The broadcast associated information can be implemented in various forms, e.g., an electronic program guide (EPG), an electronic service guide (ESG), and the like. The broadcast receiving module 411 may be configured to receive digital broadcast signals using broadcasting systems such as ATSC, DVB-T (Digital Video Broadcasting-Terrestrial), DVB-S (Satellite), MediaFLO (Media Forward Link Only), DVB-H (Handheld), ISDB-T (Integrated Services Digital Broadcast-Terrestrial), and the like. Optionally, the broadcast receiving module 411 can be configured to be suitable for other broadcasting systems as well as the above-noted digital broadcasting systems. The broadcast signal and/or broadcast associated information received by the broadcast receiving module 411 may be saved to the memory 460.

The mobile communication module 412 transmits/receives wireless signals to/from at least one of a base station, an external terminal, and a server via a mobile network. Such wireless signals may carry audio signals, video signals, and data of various types according to transceived text/multimedia messages.

The wireless Internet module 413 includes a module for wireless Internet access and may be internally or externally coupled to the mobile terminal 400. The wireless Internet technology can include WLAN (Wireless LAN) (Wi-Fi), Wibro (Wireless broadband), Wimax (World Interoperability for Microwave Access), HSDPA (High Speed Downlink Packet Access), and the like.

The short-range communication module 414 is a module for short-range communications. Suitable technologies for implementing this module include Bluetooth, radio frequency identification (RFID), infrared data association (IrDA), ultra-wideband (UWB), ZigBee, RS-232, RS-385 and the like.

The location information module 415 is a module for obtaining location information of the mobile terminal 100. And, this module may be implemented with a global positioning system (GPS) module for example.

The audio/video (AN) input unit 420 is configured to provide audio or video signal input. The AN input unit 420 may include a camera 421, a microphone 422 and the like. The camera 421 receives and processes image frames of still pictures or video, which are obtained by an image sensor in a video call mode or a photographing mode. Furthermore, the processed image frames can be displayed on the display 451.

The image frames processed by the camera 421 can be stored in the memory 460 or transmitted externally via the wireless communication unit 410. Optionally, at least two cameras 421 can be provided according to the environment of usage.

The microphone 422 receives an external audio signal in call mode, recording mode, voice recognition mode, or the like. This audio signal is processed and converted into electrical audio data. The processed audio data is transformed into a format transmittable to a mobile communication base station via the mobile communication module 412 in call mode. The microphone 422 typically includes assorted noise cancelling algorithms to cancel noise generated in the course of receiving the external audio signal.

The user input unit 430 generates input data for a user to control an operation of the terminal. The user input unit 430 may include a keypad, a dome switch, a touchpad (e.g., static pressure/capacitance), a jog wheel, a jog switch, and/or the like.

The sensing unit 440 generates sensing signals for controlling operations of the mobile terminal 400 using status measurements of various aspects of the mobile terminal. For instance, the sensing unit 440 may detect an open/closed status of the mobile terminal 400, a location of the mobile terminal 400, an orientation of the mobile terminal 400, a presence or absence of user contact with the mobile terminal 400, an acceleration/deceleration of the mobile terminal 400, and the like. For example, if the mobile terminal 400 is moved or inclined, it is able to sense a location or inclination of the mobile device. Moreover, the sensing unit 440 may sense a presence or absence of power provided by the power supply unit 490, a presence or absence of a coupling or other connection between the interface unit 470 and an external device, and the like. Meanwhile, the sensing unit 440 may include a proximity sensor 441 such as NFC (near field communication) and the like.

The output unit 450 generates output relevant to the senses of vision, hearing and touch, and may include the display 451, an audio output module 452, an alarm unit 453, a haptic module 454, and the like.

The display 451 is typically implemented to visually display (output) information processed by the mobile terminal 400. For instance, if the mobile terminal is operating in phone call mode, the display will generally provide a user interface (UI) or graphical user interface (GUI) related to a phone call. For another instance, if the mobile terminal 400 is in video call mode or photographing mode, the display 451 may display photographed or/and received images or UI/GUI.

The display module 451 may include at least one of a liquid crystal display (LCD), a thin film transistor-liquid crystal display (TFT-LCD), an organic light-emitting diode display (OLED), a flexible display and a three-dimensional display.

Some of the displays can be implemented in a transparent or optical transmittive type, which can be called a transparent display. A representative example of the transparent display is the TOLED (transparent OLED). A rear configuration of the display 451 can be implemented as the optical transmittive type as well. In this configuration, a user may be able to see an object located in rear of a terminal body through a region occupied by the display 451 of the terminal body.

Two or more displays 451 can be provided to the mobile terminal 400 in accordance with an implementation type of the mobile terminal 400. For instance, a plurality of displays can be disposed on the mobile terminal 400 in a manner of being spaced apart from a single face or being integrally formed on a single face. Alternatively, a plurality of displays may be disposed on different faces of the mobile terminal 400, respectively.

If the display 451 and a sensor (hereinafter called ‘touch sensor’) for detecting a touch action configure a mutual layer structure, the display 451 is usable as an input device as well as an output device. In this case, the touch sensor can be configured with a touch film, a touch sheet, a touchpad, or the like.

The touch sensor can be configured to convert a pressure applied to a specific portion of the display 451 or a variation of capacitance generated from a specific portion of the display 451 into an electrical input signal. Moreover, the touch sensor is configurable to detect pressure of a touch as well as a touched position or size.

If a touch input is applied to the touch sensor, signal(s) corresponding to the touch input is transferred to a touch controller. The touch controller processes the signal(s) and then transfers the processed signal(s) to the controller 480. Therefore, the controller 480 is able to know whether a prescribed portion of the display 451 is touched.

A proximity sensor 441 can be disposed on an inner region of the mobile device enclosed by the touchscreen or near the touchscreen. The proximity sensor is a sensor that detects a presence or non-presence of an object approaching a prescribed detecting surface or an object existing around the proximity sensor using an electromagnetic field strength or infrared ray without mechanical contact. Hence, the proximity sensor is more durable than a contact type sensor and also has utility higher than that of the contact type sensor.

The proximity sensor may include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor, etc. If the touch screen includes the electrostatic capacity proximity sensor, it is configured to detect the proximity of a pointer using a variation of an electric field according to the proximity of the pointer. In this configuration, the touchscreen (or touch sensor) can be sorted into a proximity sensor.

For clarity and convenience of explanation, an action for enabling the pointer approaching the touch screen to be recognized as placed on the touch screen may be named ‘proximity touch’ and an action of enabling the pointer to actually come into contact with the touch screen may be named ‘contact touch’. And, a position, at which the proximity touch is made to the touch screen using the pointer, may mean a position of the pointer vertically corresponding to the touch screen when the pointer makes the proximity touch.

The proximity sensor detects a proximity touch and a proximity touch pattern (e.g., a proximity touch distance, a proximity touch duration, a proximity touch position, a proximity touch shift state). Information corresponding to the detected proximity touch action and the detected proximity touch pattern can be output to the touch screen.

The audio output module 452 functions in various modes including a call-receiving mode, a call-placing mode, a recording mode, a voice recognition mode, and a broadcast reception mode to output audio data which is received from the wireless communication unit 410 or stored in the memory 460. During operation, the audio output module 452 may output an audio signal related to a function (e.g., call received, message received) executed in the mobile terminal 400. The audio output module 452 may include a receiver, a speaker, a buzzer and the like.

The alarm unit 453 outputs a signal for announcing the occurrence of an event of the mobile terminal 400. Typical events occurring in the mobile device may include a call signal received, a message received, a touch input received, and the like. The alarm unit 453 may output a signal for announcing the event occurrence by way of vibration as well as video or audio signal. The video or audio signal can be outputted via the display 451 or the audio output module 452. Hence, the display 451 or the audio output module 452 can be sorted into a part of the alarm unit 453.

The haptic module 454 generates various tactile effects that can be sensed by a user. Vibration is a representative one of the tactile effects generated by the haptic module 454. The strength and pattern of the vibration generated by the haptic module 454 are controllable. For instance, different vibrations can be output in a manner of being synthesized together or can be output in sequence. The haptic module 454 is able to generate various tactile effects as well as the vibration. For instance, the haptic module 454 may generate an effect attributed to the arrangement of pins vertically moving against a contact skin surface, an effect attributed to the injection/suction power of air though an injection/suction hole, an effect attributed to the skim over a skin surface, an effect attributed to a contact with an electrode, an effect attributed to an electrostatic force, and an effect attributed to the representation of a hot/cold sense using an endothermic or exothermic device. The haptic module 454 can be implemented to enable a user to sense the tactile effect through a muscle sense of a finger or an arm as well as to transfer the tactile effect through direct contact. Optionally, two or more haptic modules 454 can be provided to the mobile terminal 400 in accordance with a configuration type of the mobile terminal 400.

The memory 460 may store a program for an operation of the controller 480, or may temporarily store inputted/outputted data (e.g., phonebook, message, still image, video, etc.). And, the memory 460 may store data of vibrations and sounds of various patterns outputted in response to a touch input to the touchscreen.

The memory 460 may be implemented using any type or combination of suitable volatile and non-volatile memory or storage devices, including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory or XD memory), or other similar memory or data storage device. Furthermore, the mobile terminal 400 is able to operate in association with the web storage for performing a storage function of the memory 460 on the Internet.

The interface unit 470 may play a role as a passage to every external device connected to the mobile terminal 400 with external devices. The interface unit 470 receives data from the external devices, delivers a supplied power to the respective elements of the mobile terminal 400, or enables data within the mobile terminal 400 to be transferred to the external devices. For instance, the interface unit 470 may include a wired/wireless headset port, an external charger port, a wired/wireless data port, a memory card port, a port for coupling to a device having an identity module, audio input/output ports, video input/output ports, an earphone port, and the like.

The identity module is a chip for storing various kinds of information for authenticating a use authority of the mobile terminal 400 and may include User Identify Module (UIM), Subscriber Identity Module (SIM), Universal Subscriber Identity Module (USIM), and the like. A device having the identity module (hereinafter called ‘identity device’) can be manufactured in form of a smart card. Therefore, the identity device is connectible to the mobile terminal 400 through a port.

When the mobile terminal 400 is connected to an external cradle, the interface unit 470 becomes a passage for supplying the mobile terminal 400 with a power from the cradle or a passage for delivering various command signals input from the cradle by a user to the mobile terminal 400. Each of the various command signals inputted from the cradle or the power can operate as a signal for recognizing that the mobile terminal 400 is correctly installed in the cradle.

The controller 480 typically controls the overall operations of the mobile terminal 400. For example, the controller 480 performs the control and processing associated with voice calls, data communications, video calls, and the like. The controller 480 may include a multimedia module 481 that provides multimedia playback. The multimedia module 481 may be configured as a part of the controller 480, or implemented as a separate component. Moreover, the controller 480 is able to perform a pattern recognition processing for recognizing a writing input and a picture drawing input performed on the touchscreen as a text and an image, respectively.

The power supply unit 490 is supplied with an external or internal power and then supplies a power required for an operation of each component, under the control of the controller 480.

Various embodiments described herein may be implemented in a recording medium readable by a computer or a device similar to the computer using software, hardware, or some combination thereof for example.

For hardware implementation, the embodiments described herein may be implemented within at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, and a selective combination thereof. Such embodiments may also be implemented by the controller 480.

For software implementation, the embodiments described herein may be implemented with separate software modules, such as procedures and functions, each of which performs one or more of the functions and operations described herein. The software codes can be implemented with a software application written in any suitable programming language and may be stored in memory such as the memory 460, and executed by a controller or processor, such as the controller 480.

Meanwhile, beyond the dimension of user's hand-held use, a wearable device wearable on a body may operate or function as a digital device or an external device in the present specification. Such wearable devices may include a smart watch, smart glasses, an HMD and the like.

As shown in FIG. 1, a wearable device may exchange data with or interwork with another device mutually. The short-communication module 414 may detect (or recognize) a communication enabled wearable device around. If the detected wearable device is a device authenticated to communicate with the mobile terminal 400, the controller 480 may send at least one portion of data processed in the mobile terminal 400 to the wearable device. Hence, a user can use the data processed in the mobile terminal 400 through the wearable device. For instance, if an incoming call is received by the mobile terminal 400, a phone call is performed through the wearable device. If a message is received by the mobile terminal 400, the received message can be checked through the wearable device.

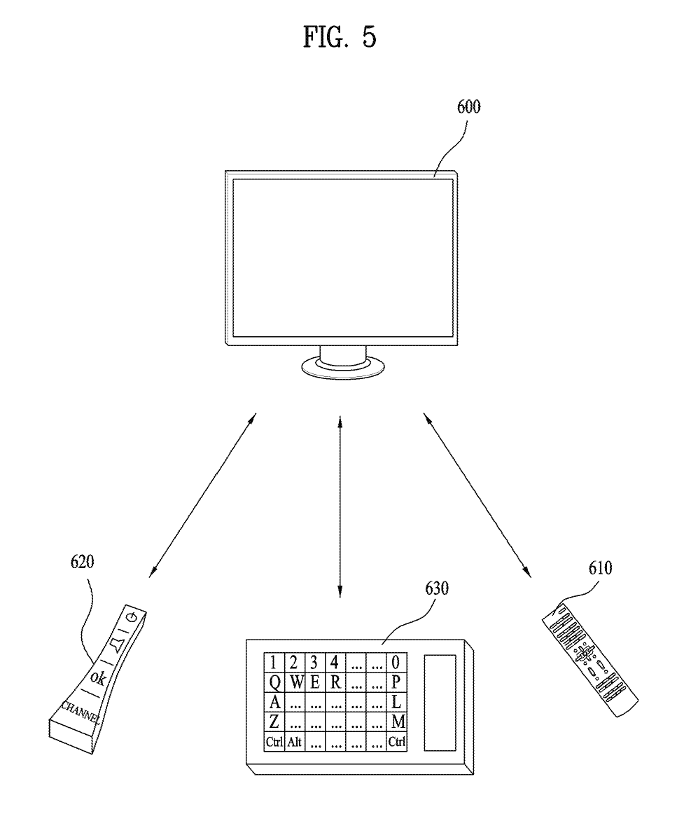

FIG. 5 is a diagram showing a control means for controlling a digital device according to one embodiment of the present invention.

In order to control a digital device 500, a front panel (not shown in the drawing) or a control means (e.g., an input means) installed in the digital device 500 is used.

Meanwhile, as a user interface device (UID) capable of a wire/wireless communication, the control means includes a remote controller 510, a pointing device 520, a key board 530, a touchpad, or the like, mainly embodied for the purpose of controlling the digital device 500. And, an external device such as the mobile terminal 120/130 shown in FIG. 1, which is connected or connectible to the digital device 500, may be included in the control means. Meanwhile, in the above description, the mobile terminal 120/130 may control the digital device using an application installed by being downloaded from or through an external server (e.g., the server 105 of FIG. 1 inclusive).

The input means can communicate with the digital device by employing at least one of communication protocols as necessary. In this case, the communication protocols may include Bluetooth, RFID (Radio Frequency Identification), IrDA (infrared Data Association), UWB (Ultra Wideband), ZigBee, DLNA (Digital Living Network Alliance), RS, LTE and the like.

With reference to accompanying drawings, various embodiments of a data swap process between a first memory and a second memory in a digital device according to the present invention are described in detail as follows.

A first memory 710 of the present invention is a RAM (random access memory) and may be included in a storage unit 318 of a digital TV shown in FIG. 3 or a memory 460 of a mobile terminal shown in FIG. 4. In the following description, the first memory 710 is assumed as a RAM.

A second memory 720 of the present invention is a memory used as a swap space of page data stored in the RAM 710 and includes at least one of a non-volatile memory and a slash memory. At least one of the non-volatile memory and the flash memory may be included in the storage unit 318 of the digital TV shown in FIG. 3 or the memory 460 of the mobile terminal shown in FIG. 4. In the following description, the second memory 720 may be assumed as a flash memory.

A swap controller 730 of a digital device according to the present invention can control overall operations for swap-out and swap-in between the RAM 710 and the flash memory 720, and details related to the swap shall be described in the following.

Meanwhile, in the present invention, the swap-out means an operation that page data of the RAM 710 are saved to or written on the flash memory 720, and the swap-in means an operation that the page data saved to the flash memory 720 are stored or written by being transferred to the RAM 710 again. And, the page data means a memory management unit of a specific size (e.g., 4 Kbytes) in the RAM 710.

The swap controller 730 of the digital device according to the present invention may operate in a manner of being included as a module or software form in the controller 325 of the digital TV of FIG. 3, or the controller 325 of the digital TV may perform the same operation of the swap controller 730 of the digital device according to the present invention.

Moreover, the swap controller 730 of the digital device according to the present invention may operate in a manner of being included as a module or software form in the controller 425 of the mobile terminal of FIG. 4, or the controller 425 of the mobile terminal may perform the same operation of the swap controller 730 of the digital device according to the present invention.

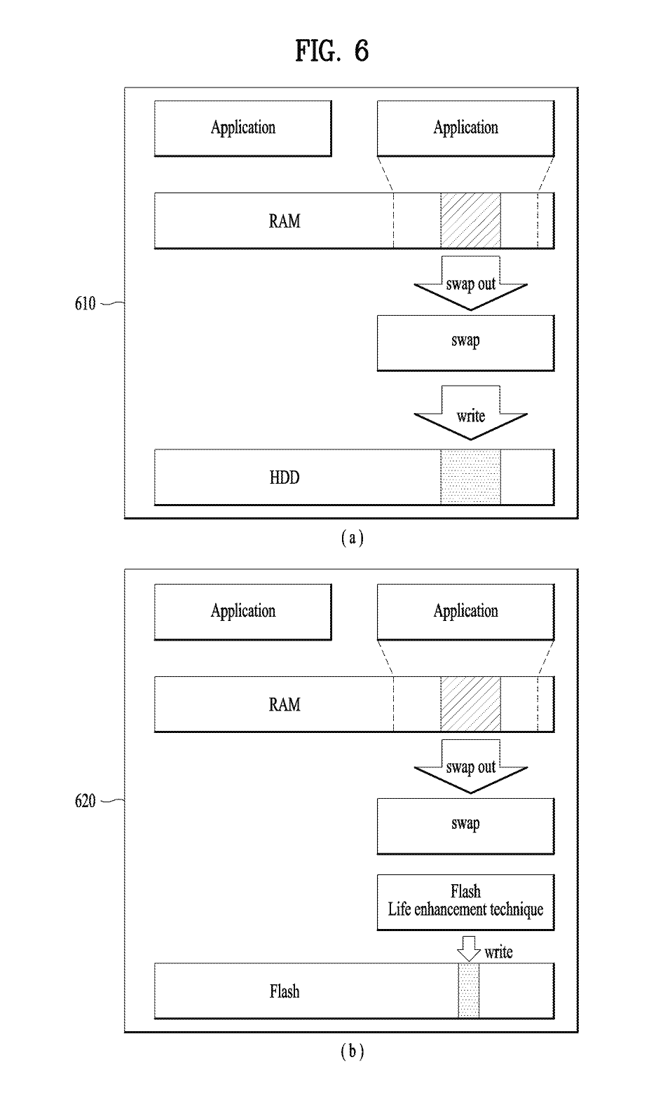

FIG. 6 is a diagram to describe a hard disk based swap technique of the related art and a flash memory based swap technique according to the present invention.

Referring to FIG. 6 (a), regarding a swap technique of the related art, in case of using a flash memory, the write count (life) per cell is about 3,000. Hence, in case of swapping a massive amount of data many times in a memory short environment, it may cause a problem that the life of the flash memory is shortened.

On the other hand, referring to FIG. 6(b), according to the present invention, a flash memory is used as a swap space of RAM, the life of the flash memory is enhanced by performing the following three operations, and a volume of the RAM versus a volume of the flash memory can be lowered using the flash memory as the swap space of the RAM.

(1) In the present invention, when page data in RAM are swapped out to a flash memory, by swapping out one of the page data duplicating due to the same substance, the write count of the flash memory can be primarily reduced. Hence, the life of the flash memory can be enhanced.

(2) By performing compression on the deduplicated page data, the write count of the flash memory can be secondarily reduced. Hence, the life of the flash memory can be enhanced.

(3) The page data deduplicated and compressed by the steps (1) and (2) are not directly written on the flash memory. Instead, in order to reduce the write count related to the life-shortening of the flash memory, the page data are buffered until having a size equal to or greater than a minimum size inputtable/outputtable to/from the flash memory. Then, the page data are swapped out to the flash memory. Hence, the write count of the flash memory can be tertiarily reduced. Hence, the life of the flash memory can be enhanced.

The steps (1) to (3) according to the present invention are described in detail with reference to the accompanying drawings as follows.

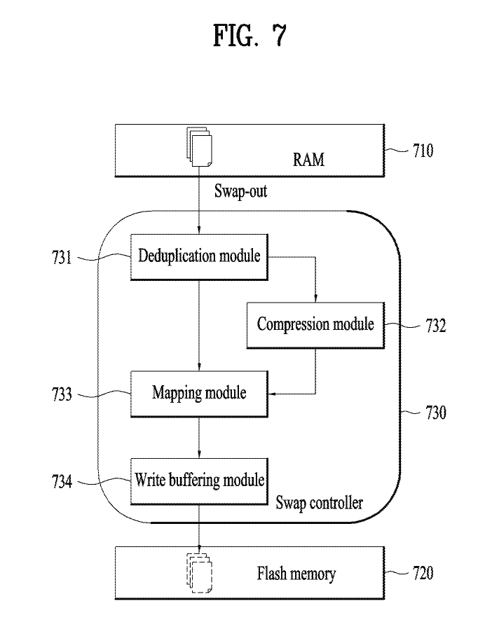

First of all, with reference to FIGS. 7 to 15, a process for performing swap-out between a RAM and a flash memory shall be described in detail.

FIG. 7 is a diagram to describe a swap-out process between a RAM and a flash memory according to the present invention.

Referring to FIG. 7, a controller 730 configured to control swap-out according to the present invention controls swap-in and swap-out operations for page data between a RAM 710 and a flash memory 720.

When the controller 730 swaps out page data within the RAM 710 to the flash memory 720, the controller 730 can swap out only one of two or more page data, which have the same substance among the page data to be swapped out, to the flash memory 720.

Namely, the controller 730 calculates discrimination values for discriminating the substances of the page data to be swapped out and is able to determine that the substances of two or more page data having the same discrimination values among the calculated discrimination values are identical to each other.

The discrimination value includes a hash value calculated by applying a preset hash function to the substances of the page data to be swapped out. And, the hash value can be calculated using the whole or partial substances of the page data to be swapped out.

The controller 730 saves swap information on at least one page data, which is not swapped out to the flash memory 720, among the page data having the same substance to the RAM 710. When the page data swapped to the flash memory 720 are swapped in to the RAM 710 again, the controller 730 reconstructs the least one page data that is not swapped out based on the swap information saved to the RAM 710. And, the controller 730 can swap in the page data swapped to the flash memory 720 and the reconstructed at least one page data to the RAM 710.

Namely, the swap information is recorded in a mapping table stored in the RAM 710. The controller 730 performs an operation of recording the mapping table in a manner of mapping a hash value of each of the page data to be swapped out and each storage location to be swapped out to the flash memory 720 to a swap offset value indicating an original location of each of the page data to be swapped out in the RAM 710. While such an operation is performed, if a hash value of a first page data is equal to that of the second page data already recorded in the mapping table, the controller 730 connects the swap offset value of the first page data to the storage location of the second page data in the mapping table.

Here, the swap information includes the storage location of the second page data connected to the swap offset value of the first page data. When swapping in the first page data, which is not swapped out to the flash memory 720, to the RAM 710 again, the controller 730 searches for the storage location of the second page data connected to the swap offset value of the first page data in the mapping table, changes the second page data stored in the found storage location into the first page data, and is then able to swap in it to the first memory.

Moreover, the controller 730 sequentially performs compression on two or more page data, failing to have the same substance among the page data to be swapped out, by a preset compression scheme, assigns a storage space amounting to a compressed size of each of the page data failing to have the same substance in the flash memory 720 by referring to the mapping table, and is able to connect a location of each of the assigned storage spaces to a swap offset value and a discrimination value of each of the page data failing to have the same substance.

Thereafter, the controller 730 performs buffering until a total size of the sequentially compressed page data becomes equal to or greater than a minimum size inputtable/outputtable to/from the flash memory 720. If the total size of the sequentially compressed page data becomes equal to or greater than the minimum size inputtable/outputtable to/from the flash memory 720, the controller 730 can swap out the buffered page data to the flash memory 720.

The above swap-out operation of the controller 730 can be performed by a deduplication module 731, a compression module 732, a mapping module 733, and a write buffering module 734. Here, the following operations of the deduplication module 731, the compression module 732, the mapping module 733, and the write buffering module 734 can be identically performed in software form by the controller 730 or may be performed in hardware block form under the control of the controller 730.

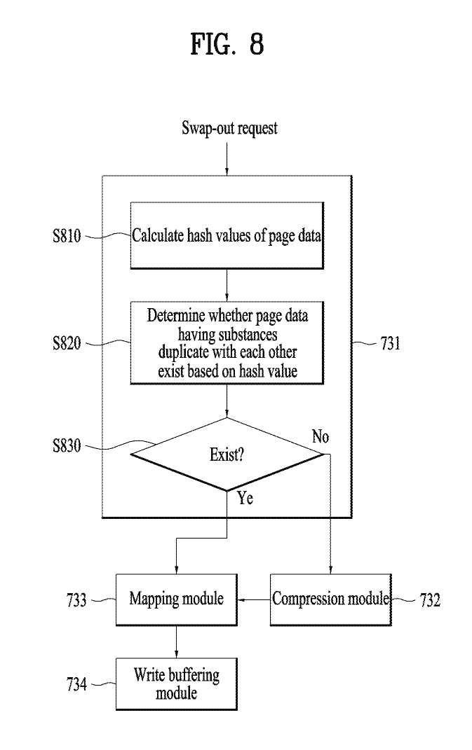

A process for deduplicating page data to be swapped out in the deduplication module 731 is described in detail with reference to FIGS. 8 to 10 as follows.

FIG. 8 is a flowchart for an operating process of a deduplication module according to the present invention.

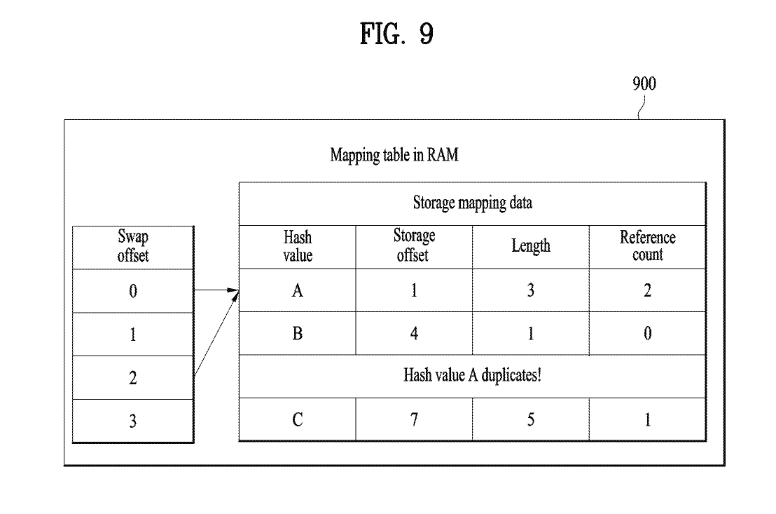

FIG. 9 is a diagram of a mapping table used in determining a presence or non-presence of duplication of page data according to the present invention.

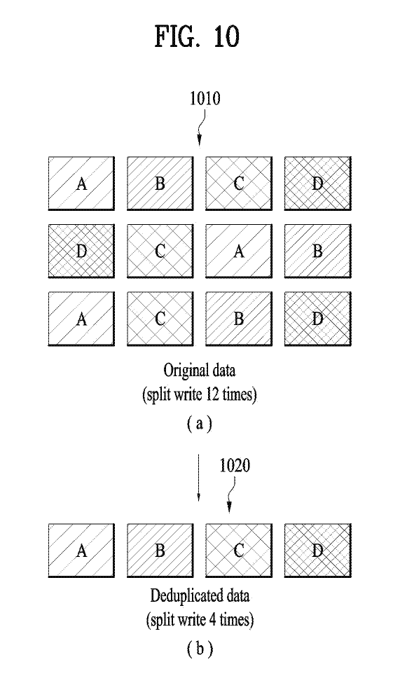

FIG. 10 is a diagram to describe a deduplicating process of page data to be swapped out according to the present invention.

Referring to FIGS. 8 to 10, if a swap-out request for saving page data in the RAM 710 to the flash memory 720 is received, the deduplication module 731 calculates hash values for discriminating substances of page data to be swapped out, respectively before swapping out the page data into the flash memory 720 under the control of the controller 730 [S810].

Here, the hash value can be calculated by at least one of cryptographic hash functions (e.g., MD5 (message-digest algorithm 5) and SHA (secure hash algorithm)) of generating 128-bit hash values. And, the hash function can be calculated in a manner of being implemented into a software or hardware block (e.g., deduplication module).

If the hash values of the page data to be swapped out are calculated, the deduplication module 731 can determine that the substances of two or more page data having the same hash value among the calculated hash values duplicate with each other.

In doing so, whether the page data to be swapped out duplicate with each other may be determined using a mapping table 900 shown in FIG. 9.

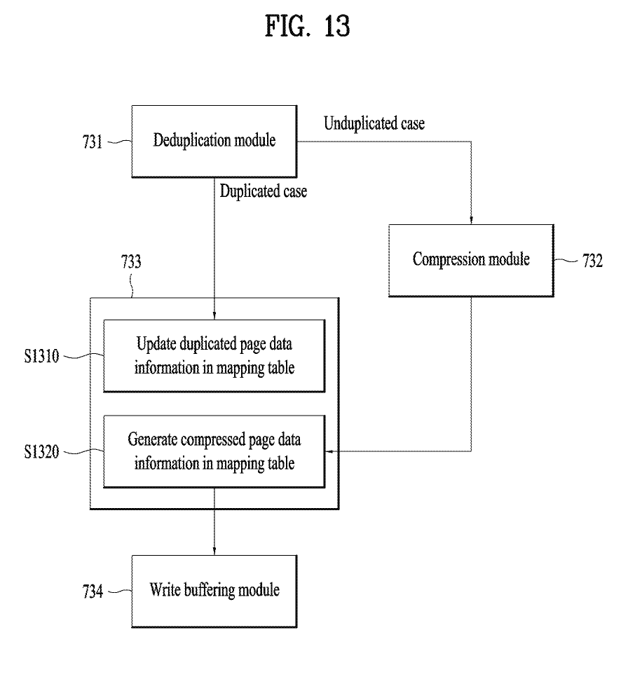

In the mapping table 900 shown in FIG. 9, storage mapping data for each page data including at least one of a hash value of each page data, a location (storage offset) of a storage space of each page data to be swapped to the flash memory 720, a data size (length) of each page data, and a duplication count (reference count) of each page data are recorded by a mapping module 733 described in FIG. 13.

As shown in FIG. 9, the following description is made on the assumption that a swap-out of first to fourth page data having swap offsets ‘0’ to ‘3’ respectively indicating original storage locations in the RAM 710 is requested. If the same hash value as the hash value ‘A’ of the first page data having the swap offset ‘0’ is not recorded in a mapping table 900, the deduplication module 731 determines that the first page data is a currently unduplicated page data.

Meanwhile, the hash value ‘A’, the storage offset ‘1’, the data length ‘3’ and the reference count ‘1’, which are first storage mapping data of the first page data, are recorded in the mapping table 900 by the mapping module 733 described in FIG. 13.

Here, the reference count ‘1’ indicates a count of non-duplication. For example, a reference count ‘2’ indicates that 1 page data having the same substance as a corresponding page data exists, a reference count ‘3’ indicates that 2 page data having the same substance as a corresponding page data exist, and a reference count ‘0’ indicates a state that a corresponding page data is not used in the RAM 710 actually due to an end of a process corresponding to the corresponding page data.

If the same hash value as the hash value ‘B’ of the second page data having the swap offset ‘1’ is not recorded in the mapping table 900, the deduplication module 731 determines that the second page data is a currently unduplicated page data.

In doing so, the hash value ‘B’, the storage offset ‘4’, the data length ‘1’ and the reference count ‘1’, which are second storage mapping data of the second page data, are recorded in the mapping table 900 by the mapping module 733 described in FIG. 13.

Yet, if a hash value A equal to the hash value ‘A’ of the third page data having the swap offset ‘2’ is recorded in the mapping table 900, the deduplication module 731 determines that the third page data is a page data duplicating with the aforementioned first page data.

If the same hash value as the hash value ‘C’ of the fourth page data having the swap offset ‘3’ is not recorded in the mapping table 900, the deduplication module 731 determines that the fourth page data is a currently unduplicated page data. And, the hash value ‘C’, the storage offset ‘7’, the data length ‘5’ and the reference count ‘1’, which are fourth storage mapping data of the fourth page data, are recorded in the mapping table 900 by the mapping module 733 described in FIG. 13.

As described above, based on the hash values of the page data to be swapped out and the mapping table 900, the deduplication module 731 determines whether the first and third page data, of which substances duplicate with each other, exist among the page data to be swapped out [S820].

If the first and third page data, of which substances duplicate with each other, exist among the page data to be swapped out [S830], as shown in FIG. 9, the deduplication module 731 sends the second and fourth page data, which are unduplicated with the first page data firstly compared with the mapping table 900 among the duplicate page data, to the compression module 732, sends swap information on the third page data except the first page data among the duplicate page data to the mapping module 733, and deletes the third page data by leaving the first page data (selected from the duplicate first and third page data) sent to the compression module 732 as it is.

In this case, the swap information for reconstructing and swapping in the deleted third page data to the RAM 710 may include the swap offset of the third page data and the first storage mapping data of the first page date duplicating with the third page data.

Although the duplicate third page data is described as deleted by the deduplication module 731 in the former description, the third page data may be deleted by the mapping module 733 described in FIG. 13 instead of the deduplication module 731. In this case, the deduplication module 731 can send the third page data to the mapping module 733 together with the swap information of the third page data.

For another example, referring to FIG. 10(a), 12 original page data 1010 to be swapped out exist. Among the original page data 1010, 2 page data duplicating with a page data A exist, 2 page data duplicating with a page data B exist, 2 page data duplicating with a page data C exist, and 2 page data duplicating with a page data D exist. Hence, when deduplication like the present invention is not performed, if the original page data 1010 are swapped out to the flash memory 720 actually, total 12 writings should be performed.

Yet, referring to FIG. 10(b), if deduplication is performed on the original page data 101, the write count of the deduplicated page data 1020 written on the flash memory 720 actually is 4. Eventually, by reducing the write count according to the swap-out, the life of the flash memory 720 can be primarily enhanced.

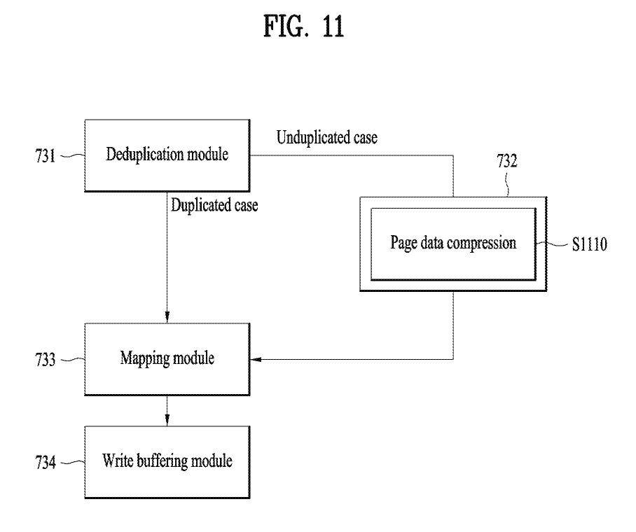

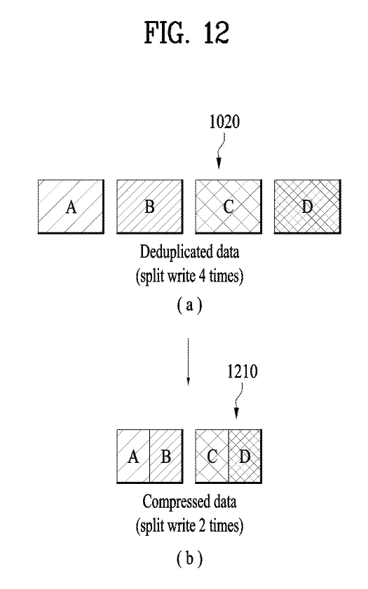

With reference to FIG. 11 and FIG. 12, a process for compressing page data to be swapped out in the compression module 732 is described in detail as follows.

FIG. 11 is a flowchart for an operating process of a compression module according to the present invention.

FIG. 12 is a diagram to describe a process for compressing deduplicated page data according to the present invention.

Referring to FIG. 11 and FIG. 12, under the control of the controller 730, if the unduplicated first, second and fourth page data re received from the deduplication module 731, the compression module 732 sequentially performs compression on the received page data by a preset compression scheme and then sends the compressed page data to the mapping module 733 [S1110].

Here, a compression function according to the preset compression scheme may employ all existing compression functions such as 1z4, 1zma and the like. If a size of the compressed page data is greater than that of an original page data, the original page data may be used intactly without progressing the compression.

FIG. 12(a) shows deduplicated page data 1020. FIG. 12(b) shows compressed page data 1210 of the deduplicated page data 1020. Eventually, as the compressed page data are compressed twice more than the existing deduplicated page data 1020, the compressed page data are written on the flash memory 720 two times reduced from four times before the compression.

As described above, the present invention performs compression on deduplicated page data, thereby further enhancing the life of the flash memory by reducing the write count of the flash memory secondarily.

An operating process of the mapping module 733 is described in detail with reference to FIG. 13 as follows.

FIG. 13 is a flowchart for an operating process of a mapping module according to the present invention.

Referring to FIG. 13, under the control of the controller, if information on the duplicated third page data is received from the deduplication module 731, the mapping module 733 updates the received swap information within the mapping table 900 of FIG. 9 [S1310].

Particularly, the received swap information may include a swap offset of the duplicated third page data and the first storage mapping data of the first page data having the same hash value as the hash value of the duplicated third page data. Moreover, the first storage mapping data of the first page data may include at least one of a hash value, a storage offset, a data length and a reference count of the first page data.

The mapping module 733 connects the swap offset (2) of the duplicated third page data to the first storage mapping data of the first page data having the same hash value as the hash value (A) of the duplicated third page data, and raised the reference count within the first storage mapping data of the first page data from ‘1’ to ‘2’ in the mapping table 900 of FIG. 9.

Namely, since the duplicated third page data has the swap offset ‘2’ and the hash value (A) of the third page data is equal to the hash value (A) of the first page data, the mapping module 733 connects the swap offset (2) of the third page data to the storage mapping data [hash value (A), storage offset (1), data length (3)] of the first page data, and changes the reference count of the first page data into ‘2’ from ‘1’.

Moreover, under the control of the controller 730, if the compressed data are sequentially received from the compression module 732, the mapping module 733 generates storage mapping data for the sequentially received page data within the mapping table 900 of FIG. 9 and then sequentially sends the sequentially received page data to the write buffering module 734 again [S1320].

Particularly, as described in FIG. 9, the mapping module 733 assigns a storage space amounting to a compressed size of each of the compressed first, second and fourth page data within the flash memory 720 by referring to the mapping table 900, generates first, second and fourth storage mapping data including hash values of the compressed first, second and fourth page data, locations of the storage spaces assigned to the compressed first, second and fourth page data, and data lengths and reference counts of the compressed first, second and fourth page data, records the generated first, second and fourth storage mapping data in the mapping table 900 of FIG. 9, and connects swap offsets of the compressed first, second and fourth page data to the generated first, second and fourth storage mapping data, respectively.

For example, in FIG. 9, the first storage mapping data of the compressed first page data includes the hash value ‘A’, the storage offset ‘1’, the data length ‘3’, and the reference count ‘2’ and the swap offset of the first page data is connected to the first storage mapping data.

The second storage mapping data of the compressed second page data includes the hash value ‘B’, the storage offset ‘4’, the data length ‘3’, and the reference count ‘0’ (currently, the second page data is not used in RAM) and the swap offset of the second page data is connected to the second storage mapping data.

And, the fourth storage mapping data of the compressed fourth page data includes the hash value ‘C’, the storage offset ‘7’, the data length ‘5’, and the reference count ‘1’ and the swap offset of the fourth page data is connected to the fourth storage mapping data.

As described above, the mapping module 733 generates the first, second and fourth storage mapping data for the compressed first, second and fourth page data and then records them in the mapping table 900. If connecting the swap offset for the duplicated third page data to the first storage mapping data of the first page data, the mapping module 733 sends the compressed first, second and fourth page data to the write buffering module 734 sequentially.

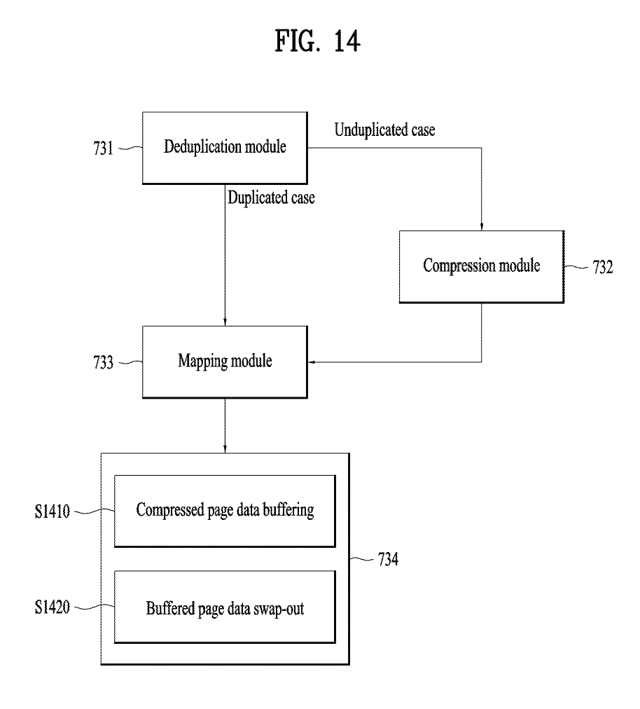

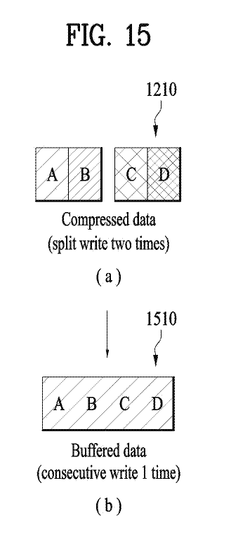

A process for merging and swapping out the compressed first, second and fourth page data to the flash memory 720 in the write buffering module 734 is described in detail with reference to FIG. 14 and FIG. 15 as follows.

FIG. 14 is a flowchart for an operating process of a write buffering module according to the present invention.

FIG. 15 is a diagram to describe a process for swapping out compressed page data to a flash memory by merging the compressed page data according to the present invention.

Referring to FIG. 14 and FIG. 15, under the control of the controller 730, the write buffering module 734 sequentially receives the compressed page data from the mapping module 733 and then collects the received page data by buffering them in the RAM 710 until a total size of the received page data becomes equal to or greater than an inputtable/outputtable (I/O) minimum size in the flash memory 720 [S1410].

Based on the storage offset to the flash memory 720 in the mapping table 900 of FIG. 9, the write buffering module 734 swaps out the collected page data to the flash memory 720 at a time [S1420].

FIG. 15(a) shows the page data 1210 compressed by the compression module 732. FIG. 15(b) shows that the compressed data are written on the flash memory 720 at a time by being buffered in the RAM 710 until a total size of the compressed page data 1210 becomes equal to or greater than an inputtable/outputtable (I/O) minimum size in the flash memory 720.

Namely, after the 12 original page data to be swapped out in FIG. 10 have gone through the deduplication process according to the present invention, there remain 4 page data. This reduces the write count on the flash memory 720 into 4 times from 12 times. Through the compressing process of FIG. 12, the write count on the flash memory 720 is reduced into 2 times from 4 times. Through the buffering process of FIG. 15, the write count on the flash memory 720 is reduced into 1 time from 2 times. Thus, as the write count can be remarkably reduced in case of swapping out page data to the flash memory 720, the life of the flash memory 720 can be enhanced eventually.

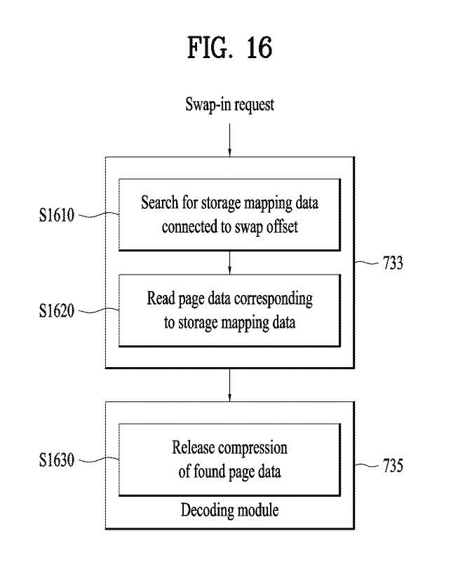

A process for swapping in the page data, which were swapped to the flash memory 720, to the RAM 710 again is described in detail with reference to FIG. 16 as follows.

FIG. 16 is a diagram to describe a swap-in process between a RAM and a flash memory according to the present invention.

Referring to FIG. 16, if receiving a request for swapping in the swapped-out page data of the RAM 710 to the flash memory 720 by the process of FIGS. 7 to 15, the controller 730 searches the mapping table 900 for storage mapping data connected to swap offsets of the swap-in requested page data through the mapping module 733 [S1610].

For example, in the description of FIG. 9 and FIG. 13, the swap offsets of the first, second and fourth page data are connected to the first, second and fourth storage mapping data in the mapping table 910, respectively. The swap offset of the deduplicated third page data is connected to the first storage mapping data together with the first page data. And, the controller 730 searches for the first, second and fourth storage mapping data as the storage mapping data connected to swap offsets of the swap-in requested page data.

Subsequently, the controller 730 searches for page data corresponding to the found storage mapping data through the mapping module 733 [S1620].

Namely, through the mapping module 733, the controller 730 searches the found storage mapping data for storage offsets and data lengths of the swap-in requested page data in the flash memory 720 and then reads the page data stored at the found storage offsets, respectively [S1620].

In doing so, since the first storage mapping data is connected to the non-deduplicated first page data and the deduplicated third page data together, in order to reconstruct the first to fourth page data all, the controller 730 reads the first, second and fourth page data stored at the storage offsets of the first, second and fourth storage mapping data through the mapping module 733, reads the first page data stored at the storage offset of the first storage mapping data once more, and then changes the once-more read first page data into the deduplicated third page data.

If the initially swap-out requested first to fourth page data are read from the flash memory 720 by the above process, the controller 730 releases compression through the decoding module 735 using the same algorithm of the scheme of compressing the first to fourth page data.

And, the controller 730 finally swaps in the decompressed first to fourth page data to the storage offsets of the RAM 710 corresponding to the swap offsets of the first to fourth page data, respectively.

In this case, if the compression of the first page data is released, the controller 730 may generate a third page data that is a copy of the first page data without performing the process for reading the third page data.

Moreover, if at least one of the first to fourth page data is not compressed, the compression process may be omitted for the uncompressed page data.

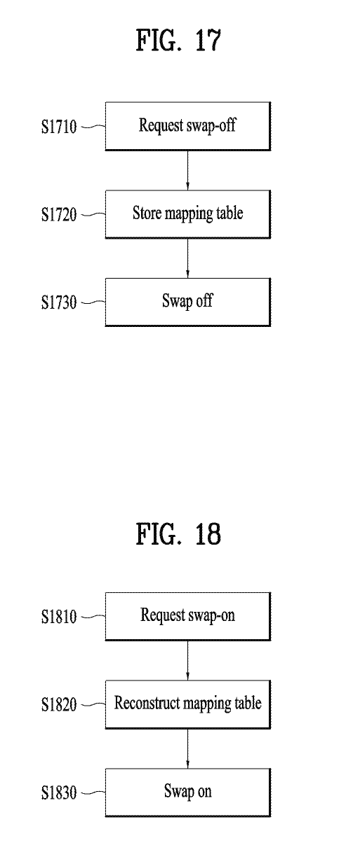

FIG. 17 is a flowchart of a process for turning off a swap function using a mapping table according to the present invention. FIG. 18 is a flowchart of a process for turning on a swap function using a mapping table according to the present invention.

Referring to FIG. 17, if receiving a request for turning off a swap function [S1710], the controller 730 can save the mapping table 900 described in FIGS. 7 to 16 to the flash memory 720 to be available thereafter despite that the mapping table 900 is deleted from the RAM 710 [S1720].

If the mapping table 900 is saved to the flash memory 720, the controller 730 can turn off the swap function [S1730].

Before the power of the digital device is turned off, the controller 730 saves the mapping table described in FIGS. 7 to 16 to the flash memory 720 in order to use the mapping table 900 later despite the mapping table 900 is deleted. After the mapping table 900 has been saved to the flash memory 720, the controller 730 may turn off the power of the digital device.

Referring to FIG. 18, if receiving a request for turning on the swap function [S1810], the controller 730 reconstructs the mapping table 900 saved to the flash memory 720 in FIG. 17, saves it to the RAM 710 [S1820], and then turns on the swap function [S1830].

Moreover, referring to FIG. 18, when the power of the digital device is turned on, the controller 730 is activated, reconstructs the mapping table 900 saved to the flash memory 720, and then saves it to the RAM 710.

Accordingly, the present invention provides the following effects/features.

According to one of various embodiments of the present invention, as a flash memory is usable as a swap space of data stored in RAM, a volume of the RAM can be reduced so as to lower the product manufacturing cost.

According to another one of various embodiments of the present invention, the reduced life of a flash memory can be remarkably improved in case of using the flash memory as a swap space of RAM.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A digital device, comprising:
a first memory;
a second memory used as a swap space of page data stored in the first memory; and
a controller configured to control swap-in and swap-out operations for page data between the first memory and the second memory,
wherein when page data in the first memory are swapped out to the second memory, the controller is further configured to swap out only one of a plurality of page data having the same substance among the page data to be swapped out to the second memory only.

2. The digital device of claim 1, wherein:
the first memory includes a random access memory (RAM), and
the second memory comprises a flash memory.

3. The digital device of claim 1, wherein the controller is further configured to:
calculate discrimination values for discriminating substances of the page data to be swapped out, respectively, and
determine that the substances of a plurality of page data having the same discrimination value among the calculated discrimination values are identical to each other.

4. The digital device of claim 3, wherein the discrimination value includes a hash value calculated by applying a preset hash function to the substances of the page data to be swapped out.

5. The digital device of claim 4, wherein the hash value is calculated using all or some of the substances of the page data to be swapped out.

6. The digital device of claim 3, wherein the controller is further configured to:
store swap information on at least one page data failing to be swapped out to the second memory among the page data having the same substances to the first memory,
when swapping in the page data swapped out to the second memory to the first memory, reconstruct the at least one page data failing to be swapped out based on the swap information stored to the first memory, and
swap in the page data swapped out to the second memory and the reconstructed at least one page data to the first memory.

7. The digital device of claim 6, wherein:
the first memory includes a mapping table,
the controller is further configured to:
perform an operation of recording the mapping table in a manner of mapping a discrimination value of each of the page data to be swapped out and each storage location to be swapped out to the second memory to a swap offset of each of the page data to be swapped out, and
while the operation is performed, when the discrimination value of a first page data is equal to that of the second page data already recorded in the mapping table, connect the swap offset of the first page data to the storage location of the second page data in the mapping table.

8. The digital device of claim 7, wherein:
the swap information includes the storage location of the second page data connected to the swap offset value of the first page data, and
the controller is further configured to:
when swapping in the first page data, which is not swapped out to the second memory, to the first memory, search for the storage location of the second page data connected to the swap offset of the first page data in the mapping table, and
change the second page data stored in the searched storage location into the first page data, and swaps in the changed data to the first memory.

9. The digital device of claim 7, wherein the controller is further configured to:
sequentially perform compression on a plurality of page data, failing to have the same substances among the page data to be swapped out, by a preset compression scheme, assign a storage space amounting to a compressed size of each of the page data failing to have the same substances in the second memory by referring to the mapping table, and
connect a location of each of the assigned storage spaces to a swap offset value and a discrimination value of each of the page data failing to have the same substances.

10. The digital device of claim 9, wherein the controller is further configured to:
perform buffering until a total size of the sequentially compressed page data becomes equal to or greater than a minimum size inputtable/outputtable to/from the second memory, and
when the total size of the sequentially compressed page data becomes equal to or greater than the minimum size inputtable/outputtable to/from the second memory, swap out the buffered page data to the second memory.

11. A method of controlling a digital device having a first memory and a second memory used as a swap space of page data stored in the first memory, the method comprising:
receiving a swap-out request for storing page data in the first memory to the second memory;
obtaining a plurality of page data having the same substances among the page data to be swapped out; and
swapping out only one of the obtained page data to the second memory in swapping out the page data to the second memory.

12. The method of claim 11, wherein:
the first memory includes a random access memory (RAM), and
the second memory comprises a flash memory.

13. The method of claim 11, further comprising:
calculating discrimination values for discriminating substances of the page data to be swapped out, respectively, and
determining that the substances of a plurality of page data having the same discrimination value among the calculated discrimination values are identical to each other.

14. The method of claim 13, wherein the discrimination value includes a hash value calculated by applying a preset hash function to the substances of the page data to be swapped out.

15. The method of claim 14, wherein the hash value is calculated using all or some of the substances of the page data to be swapped out.

16. The method of claim 13, further comprising:
storing swap information on at least one page data failing to be swapped out to the second memory among the page data having the same substances to the first memory;
when swapping in the page data swapped out to the second memory to the first memory, reconstructing the at least one page data failing to be swapped out based on the swap information stored to the first memory, and
swapping in the page data swapped out to the second memory and the reconstructed at least one page data to the first memory.

17. The method of claim 16, further comprising:
performing an operation of recording a mapping table included in the first memory in a manner of mapping a discrimination value of each of the page data to be swapped out and each storage location to be swapped out to the second memory to a swap offset of each of the page data to be swapped out, and
while the operation is performed, when the discrimination value of a first page data is equal to that of the second page data already recorded in the mapping table, connecting the swap offset of the first page data to the storage location of the second page data in the mapping table.

18. The method of claim 17, wherein the swap information includes the storage location of the second page data connected to the swap offset value of the first page data, and
the method is further comprising:
when swapping in the first page data, which is not swapped out to the second memory, to the first memory, searching for the storage location of the second page data connected to the swap offset of the first page data in the mapping table, and
changing the second page data stored in the searched storage location into the first page data, and swaps in the changed data to the first memory.

19. The method of claim 17, further comprising:
sequentially performing compression on a plurality of page data, failing to have the same substances among the page data to be swapped out, by a preset compression scheme,
assigning a storage space amounting to a compressed size of each of the page data failing to have the same substances in the second memory by referring to the mapping table, and
connecting a location of each of the assigned storage spaces to a swap offset value and a discrimination value of each of the page data failing to have the same substances.

20. The method of claim 19, further comprising:
performing buffering until a total size of the sequentially compressed page data becomes equal to or greater than a minimum size inputtable/outputtable to/from the second memory, and
when the total size of the sequentially compressed page data becomes equal to or greater than the minimum size inputtable/outputtable to/from the second memory, swapping out the buffered page data to the second memory.
